(19) United States
(12) Patent Application Publication
(10) Pub. No.: US 2017/0337084 A1
(43) Pub. Date: Nov. 23, 2017

(54) COMPUTE UNIT INCLUDING THREAD DISPATCHER AND EVENT REGISTER AND METHOD OF OPERATING SAME TO ENABLE COMMUNICATION

(71) Applicant: KnuEdge Incorporated, San Diego, CA (US)

(72) Inventors: Ramkumar Jayaseelan, Austin, TX (US); Raghuram S. Tupuri, Austin, TX (US); Sadagopan Srinivasan, Austin, TX (US); Thomas Andrew Hartin, Austin, TX (US)

(21) Appl. No.: 15/157,942

(22) Filed: May 18, 2016

(51) Int. Cl. G06F 9/50

(52) U.S. Cl. CPC G06F 9/5016

(57) ABSTRACT

An apparatus includes a set of one or more processing cores, a thread dispatcher, and an event register of a first compute unit. The set of one or more processing cores is configured to execute a set of threads. The thread dispatcher is coupled to the set of one or more processing cores and is configured to select threads of the set of threads for execution by the set of one or more processing cores. The thread dispatcher is further configured to refrain from selecting a first thread of the set of threads for execution in response to a first value of one or more bits of the event register and to select the first thread for execution in response to a second value of the one or more bits.

### FIELD

This disclosure is generally related to electronic devices and more particularly to electronic devices that include processors that include compute units that execute instructions.

### BACKGROUND

Electronic devices may include one or more processors that execute instructions to perform operations. In a multiprocessor configuration, an electronic device may include multiple processors that may each execute instructions to increase processing speed, processing capability, or both. Further, a processor may have a threaded configuration in which multiple threads of execution (e.g., multiple programs) “share” resources, such as compute units of the processor.

In some circumstances, a thread may synchronize with another thread, such as by requesting data from the other thread, providing data to the other thread, or both. In this case, a memory may be used to enable the synchronization. For example, a thread may write a copy of data to the memory, and another thread may access the copy of the data. Synchronizing threads in such a manner may temporarily decrease available storage space of the memory. Further, synchronizing threads in such a manner uses bandwidth of an interface to the shared memory, which may result in latency of memory operations.

### SUMMARY

In an illustrative example, a compute unit includes a thread dispatcher, a set of one or more processing cores, and an event register. The thread dispatcher is configured to dispatch threads for execution at the set of one or more processing cores based on the event register. For example, the event register may be configured to store one or more bits that indicate a status of a first thread in order to enable inter-thread communication, which may reduce or avoid instances of thread synchronization using a memory.

To further illustrate, in some cases, the one or more bits of the event register may indicate that the first thread is waiting to receive a message from a second thread of a second compute unit via a message passing router that connects the first compute unit and the second compute unit. In this case, the thread dispatcher may refrain from dispatching the first thread for execution during a particular time period, such as by dispatching another thread for execution during the particular time period. After the message is received from the second thread via the message passing router, the thread dispatcher may set a second value of the one or more bits (e.g., to indicate a ready status of the first thread).

Depending on the particular example, a message may be sent from one thread to another thread or from one thread to multiple threads (e.g., to broadcast the message to multiple threads using a “one-to-many” technique). In another illustrative example, the one or more bits may indicate that the first thread is waiting for messages from multiple threads (e.g., using a “many-to-one” technique).

By sending messages using a message passing router, communications may be “offloaded” from a memory interface to the message passing router. As a result, usage of memory interface bandwidth and usage of memory storage may be reduced, improving device performance. For example, a message passing router may include low-overhead message passing interconnects associated with relatively low latency, which may improve speed of inter-thread communication operations as compared to using a shared memory interface that is configured to perform “bulk” transfer of large amounts of data (e.g., files). Other illustrative aspects, examples, and advantages of the disclosure are described further below with reference to the drawings.

### BRIEF DESCRIPTION OF THE DRAWINGS

FIG. 1 is a block diagram of an illustrative example of a compute unit that includes an event register and a thread dispatcher configured to dispatch threads for execution based on the event register.

FIG. 2 is a block diagram of an illustrative example of a system that includes a compute unit that includes an event register and a thread dispatcher configured to dispatch threads for execution based on the event register.

FIG. 3 is a flow chart of an illustrative example of a method that includes adjusting a value of one or more bits stored at an event register of a compute unit, such as the compute unit of FIG. 1.

FIG. 4 is a flow chart of an illustrative example of a method that includes accessing an event register to determine execution of threads of a compute unit, such as the compute unit of FIG. 1.

### DETAILED DESCRIPTION

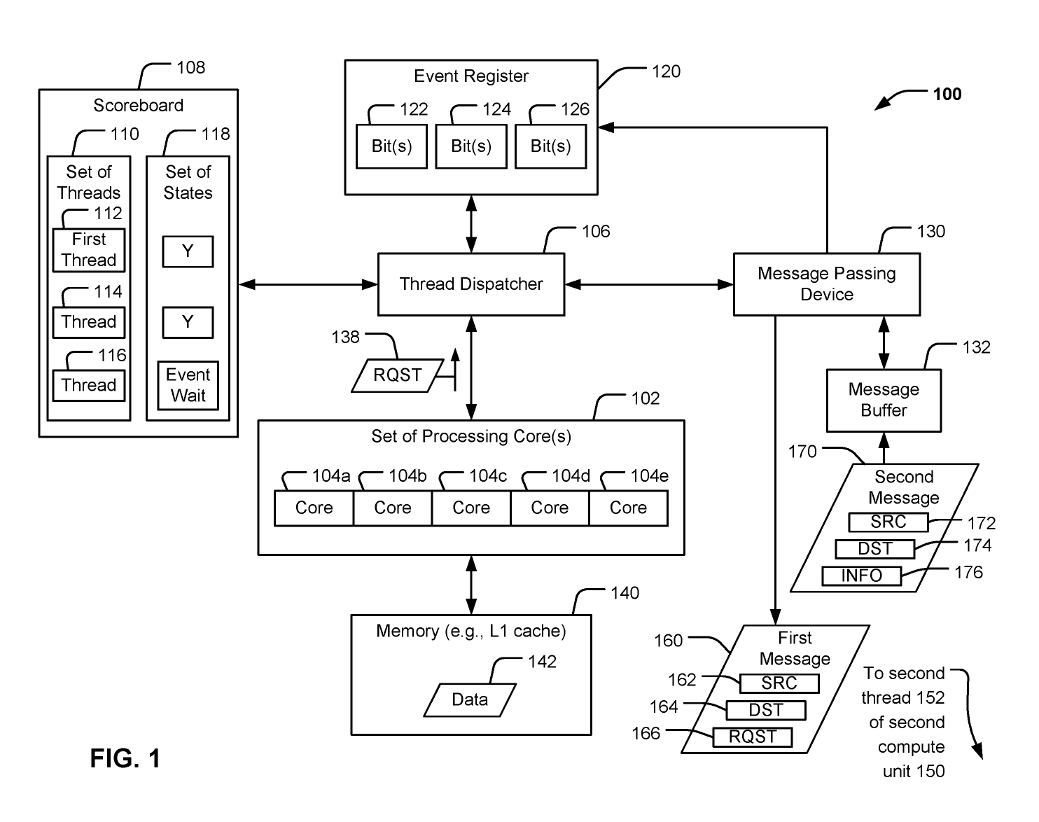

FIG. 1 depicts an illustrative example of a first compute unit 100 (also referred to herein as a compute engine). The first compute unit 100 may be included in an integrated circuit, as an illustrative example. The first compute unit 100 may be included in a processor, such as a graphics processing unit (GPU), as an illustrative example.

The first compute unit 100 includes a set of one or more processing cores 102, such as representative cores 104a-104e. In some implementations, the set of one or more processing cores 102 may have a single-instruction, multiple data (SIMD) configuration. In the illustrative example of FIG. 1, the set of one or more processing cores 102 includes five cores. In other implementations, the set of one or more processing cores 102 may include a different number of cores (e.g., one core, two cores, six cores, or another number of cores).

The set of one or more processing cores 102 is configured to execute a set of threads 110. To illustrate, the set of one or more processing cores 102 may be configured to execute a first thread 112, a thread 114, and a thread 116. Each thread of the set of threads 110 may include a set of instructions, such as instructions of one or more programs. The first compute unit 100 may read instructions of the set of threads 110 from and may write instructions of the set of threads 110 to a memory, such as an instruction cache, a non-volatile memory, or a combination thereof. Although the example of FIG. 1 illustrates that the set of threads 110 includes three threads, in other implementations, the set of threads 110 may include more than three threads or fewer than three threads.

The first compute unit 100 further includes a thread dispatcher 106 coupled to the set of one or more processing cores 102. The thread dispatcher 106 is configured to select (e.g., dispatch) threads of the set of threads 110 for execution by the set of one or more processing cores 102. To further illustrate, the thread dispatcher 106 may be coupled to or may include a scoreboard 108 that indicates a set of states 118 associated with the set of threads 110. The set of states 118 may include an active state (“Y”), a ready state, a memory access wait state, an event wait state (“event wait”), or one or more other states, as illustrative examples. In the example of FIG. 1, the scoreboard 108 indicates that the first thread 112 is associated with the ready state, the thread 114 is associated with the ready state, and the thread 116 is associated with the event wait state. As used herein, an event may include an inter-thread communication operation, as an illustrative example.

The first compute unit 100 further includes an event register 120. The event register 120 is coupled to the thread dispatcher 106. The event register 120 may be configured to store bits indicating status information of threads of the set of threads 110. For example, the event register 120 is configured to store one or more bits 122, one or more bits 124, and one or more bits 126.

The first compute unit 100 may further include a message passing device 130 and one or more message buffers, such as a message buffer 132. The message passing device 130 may be coupled to the thread dispatcher 106 and to the event register 120. The message buffer 132 is coupled to the message passing device 130.

The first compute unit 100 also includes a memory 140, such as a level-one (L1) cache. The memory 140 may store data 142. For example, the set of one or more processing cores 102 may execute the set of threads 110 to read the data 142 from the memory 140, to write the data 142 to the memory 140, to perform one or more other operations, or a combination thereof.

During operation, the first compute unit 100 may execute instructions of the set of threads 110 using the set of one or more processing cores 102. The thread dispatcher 106 may select threads of the set of threads 110 for execution by the set of one or more processing cores 102. For example, the thread dispatcher 106 may select a proper subset of the set of threads 110 for execution by the set of one or more processing cores 102 for a particular time period (e.g., one or more clock cycles) of the first compute unit 100.

The set of one or more processing cores 102 may execute instructions of the set of threads 110 to perform operations. In an illustrative implementation, the set of one or more processing cores 102 may execute instructions of the set of threads 110 to perform vector operations (e.g., in connection with a graphics processing application), and the data 142 may include vector data. Alternatively or in addition, the set of one or more processing cores 102 may execute instructions of the set of threads 110 to perform scalar operations, and the data 142 may include scalar data.

In some cases, a thread of the set of threads 110 may communicate with another thread, such as another thread of the first compute unit 100, a thread of another compute unit (e.g., a second thread 152 of a second compute unit 150 that is coupled to the first compute unit 100), or both. For example, the first thread 112 may determine that information is to be sent to another thread, is requested from another thread, or both. To further illustrate, execution of one or more instructions of the first thread 112 may depend on information from another compute unit, such as a result of an operation performed during execution of the second thread 152 by the second compute unit 150.

Upon determining that information is to be requested from the second thread 152 of the second compute unit 150, the first thread 112 may initiate a request 138 for the information from the second compute unit 150. To illustrate, the core 104a may execute instructions of the first thread 112 to determine that the information is to be requested from the second thread 152 of the second compute unit 150. In this example, the request 138 may specify one or more of a thread identification (ID) of the second thread 152 or a type of information to be requested from the second thread 152. In response to receiving the request 138 from the core 104a, the thread dispatcher 106 may provide the request 138 to the message passing device 130. In an alternative implementation, the core 104a may be configured to provide the request 138 to the message passing device 130 (instead of to the thread dispatcher 106).

In some implementations, an instruction set architecture (ISA) associated with the first compute unit 100 specifies an instruction that initiates the request 138. For example, the ISA may define a particular instruction that initiates the request 138 upon execution of the instruction. The instruction may include an argument (or operand) specifying one or more threads (e.g., the second thread 152), one or more compute units (e.g., the second compute unit 150), a type of information to be requested, or a combination thereof, as illustrative examples.

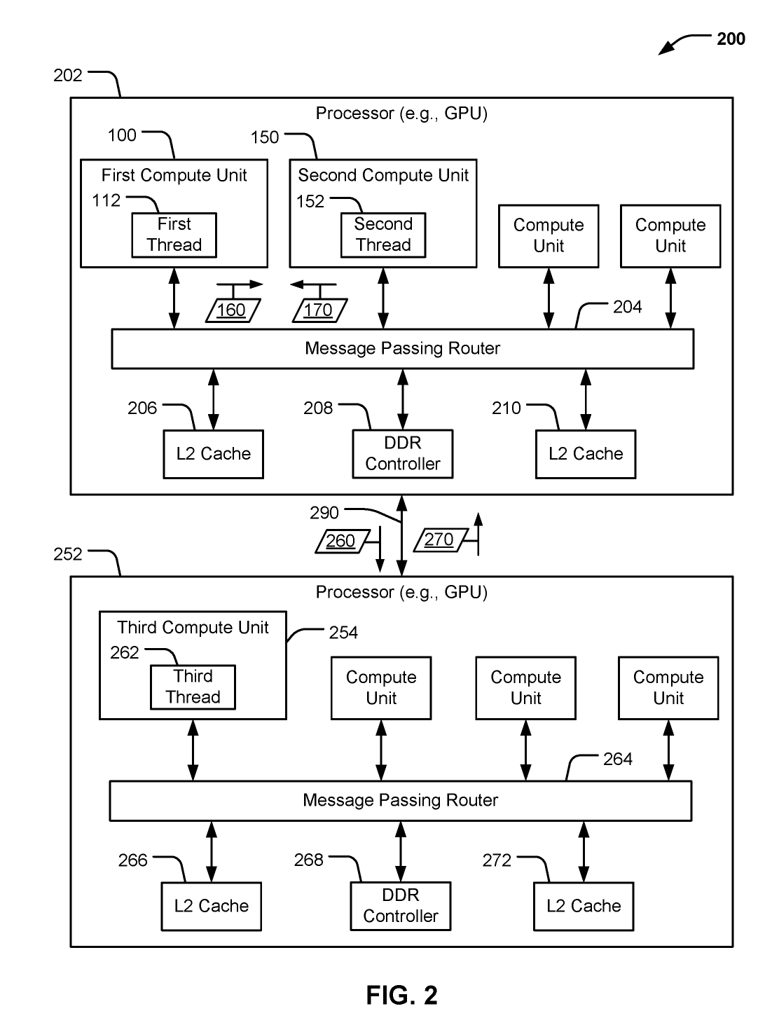

Based on the request 138, the message passing device 130 may generate an outgoing message, such as a first message 160. In an illustrative implementation, the first message 160 includes a packet or a portion of a packet, such as a flow control digit (flit). The first message 160 may include a source field 162, such as an ID associated with the first compute unit 100, an ID of the first thread 112, or both. The first message 160 may include a destination field 164, such as an ID associated with the second compute unit 150, an ID of the second thread 152, or both. The first message 160 may further include a request field 166, such as a request for information from the second thread 152. In an illustrative implementation, the message passing device 130 is configured to send the first message 160 to the second compute unit 150 using a message passing router, as described further with reference to FIG. 2.

The message passing device 130 may set a value of one or more bits at the event register 120 in response to the request 138 (or in response to sending the first message 160). In an illustrative example, the message passing device 130 is configured to set a value of the one or more bits 122 to indicate a status of the first thread 112 in response to the request 138 (or in response to sending the first message 160), such as to indicate a change of status of the first thread 112 from an active status to an inactive status. For example, the one or more bits 122 may be reserved to indicate a status of the first thread 112. The thread dispatcher 106 may be configured to set a first value (e.g., a logic zero value, as an illustrative example) of the one or more bits 122 to indicate an event wait status. In this case, the one or more bits 122 may indicate that the first thread 112 has an event wait status and is waiting to receiving a message. In some implementations, the one or more bits 122 includes an identification of a source of the message, such as an ID of the second compute unit 150, an ID of the second thread 152 of the second compute unit 150, or both. In other implementations, the one or more bits 122 may not include an identification of the source of the message, such as if the one or more bits 122 include a single bit that does not indicate a source of the message.

In some implementations, the thread dispatcher 106 may be configured to update the scoreboard 108 based on the event register 120 (e.g., to indicate an event wait state of the first thread 112). For example, upon detecting that the one or more bits 122 indicate that the first thread 112 has an inactive status, the thread dispatcher 106 may be configured to update the scoreboard 108 to indicate a state of the first thread 112 (e.g., an event wait state).

In some examples, the first thread 112 may enter an inactive mode (e.g., a sleep mode or a stalled mode) while waiting for a response from the second compute unit 150 to the first message 160. In this case, the one or more bits 122 may have a particular value (e.g., a first value, such as a logic zero value) indicating that the thread dispatcher 106 is to refrain from dispatching the first thread 112 for execution until detecting another value (e.g., a second value, such as a logic one value) of the one or more bits 122. Alternatively, in some cases, the first thread 112 may remain in an active mode while waiting for a response from the second compute unit 150 to the first message 160, such as if the first thread 112 is associated with one or more tasks to be performed that do not depend on a response to the first message 160. In this case, the message passing device 130 may refrain from setting the first value of the one or more bits 122 (e.g., until the first thread 112 is ready to enter an inactive mode). Use of the event register 120 and the message passing device 130 may enable inter-thread communication operations using a low-overhead message passing router (which may reduce communication latency and bandwidth consumption associated with communication using a high-overhead shared memory that is accessed by multiple compute units), as described further with reference to FIG. 2.

The thread dispatcher 106 is configured to access the event register 120 and to select threads of the set of threads 110 for execution by the set of one or more processing cores 102 based on the event register 120. As an illustrative example, each of the set of threads 110 may be associated with a set of time periods (also referred to herein as time slots). The thread dispatcher 106 may select threads of the set of threads 110 for execution during the set of time slots, such as by selecting threads using a round robin technique, using a prioritized scheme, or using another technique. In some implementations, during a particular time slot of the set of time slots, the set of one or more processing cores 102 executes a proper subset (e.g., two threads) of the set of threads 110. In response to determining that the first thread 112 is associated with a particular time slot, the thread dispatcher 106 may access the event register 120 to determine a status associated with the first thread 112. The thread dispatcher 106 is configured to refrain from selecting the first thread 112 for execution (e.g., during a particular time slot) in response to determining that the message is unavailable (e.g., has not been received by the message buffer 132) based on the one or more bits 122, such as in response to determining based on the one or more bits 122 that a message from the second compute unit 150 is unavailable (e.g., has not been received by the message buffer 132). Depending on the particular example, the thread dispatcher 106 may select another thread (e.g., the thread 114 or the thread 116) in place of the selecting the first thread 112 for execution by the set of one or more processing cores 102 during the particular time slot, or the set of one or more processing cores 102 may stall during the particular time slot (e.g., if the event register 120 indicates that all of the threads in the set of threads 110 are in an event wait state).

After sending the first message 160, the first compute unit 100 may receive an incoming message from the second compute unit 150, such as by receiving a second message 170 from the second compute unit 150. The second message 170 may include a packet or a portion of a packet, such as a flit. The message buffer 132 may be configured to store (e.g., buffer) the second message 170. The second message 170 may include a source field 172, such as an ID of the second compute unit 150, an ID of the second thread 152 of the second compute unit 150, or both. The second message 170 may include a destination field 174, such as an ID of the first compute unit 100, an ID of the first thread 112, or both. The second message 170 may further include information 176, such as information that is identified by the request field 166 of the first message 160 and that is used to synchronize the threads 112, 152.

The second message 170 may be received in connection with an inter-thread communication operation (e.g., a point-to-point communication) between the first thread 112 and the second thread 152 to enable the first thread 112 to synchronize with the second thread 152. As a non-limiting illustrative example, the information 176 may include data generated by the second thread 152, and the first thread 112 of the first compute unit 100 may use the information 176 to synchronize with the second thread 152. Synchronization using an inter-thread communication operation as described herein may be associated with lower overhead (e.g., may be “lightweight”) as compared to certain other higher overhead synchronization techniques that copy information to a shared memory that is accessed by multiple compute units (which may incur latency due to waiting to access the shared memory).

To further illustrate, the synchronization may include synchronization of processes performed by the first thread 112 and the second thread 152. To illustrate, the request field 166 may indicate that the processes are to be initiated or terminated, and a value indicated by the information 176 may indicate acceptance or rejection of initiation or termination of the processes. Alternatively or in addition, the synchronization may include synchronization of data used by the first thread 112 and the second thread 152. To illustrate, the request field 166 may indicate that data is requested by the first compute unit 100, and the information 176 may include the data. To further illustrate, the threads 112, 152 may jointly perform synchronized clustered processes of a data mining application, a synchronized “producer-consumer pipeline” process that exchanges data using the messages 160, 170, or a pipelined-parallel process that uses point-to-point synchronization using the messages 160, 170, as illustrative examples.

In some cases, receiving the information 176 from the second compute unit 150 may reduce or avoid a delay associated with retrieving the information 176 from a memory that is shared by the first compute unit 100 and the second compute unit 150. To illustrate, operations to access certain memory devices may be associated with relatively large “overhead,” such as a wait time to acquire a “lock” to access a memory device. Alternatively or in addition, receiving the information 176 from the second compute unit 150 may enable information coherency for the first compute unit 100. For example, directly exchanging information using the messages 160, 170 may avoid a circumstance in which the first compute unit 100 accesses an incoherent or “stale” copy of the information 176 from a memory that is shared by the first compute unit 100 and the second compute unit 150 prior to updating of the information 176 by the second compute unit 150.

The message passing device 130 may be configured to adjust a value of the one or more bits 122 in response to the second message 170. For example, the message passing device 130 may be configured to set a second value (e.g., a logic one value, as an illustrative example) of the one or more bits 122 to indicate a ready status of the first thread 112 in response to the second message 170.

The thread dispatcher 106 is configured to select the first thread 112 for execution in response to determining that the second message 170 is available at the message buffer 132 based on the one or more bits 122. For example, in response to determining that the one or more bits 122 indicate a ready status of the first thread 112, the thread dispatcher 106 may select the first thread 112 for execution during a particular time slot associated with the first thread 112. The thread dispatcher 106 may be configured to update the scoreboard 108 based on the event register 120 (e.g., to indicate a ready state of the first thread 112).

During execution of the first thread 112, the information 176 may be accessed (e.g., by retrieving the information 176 from the message buffer 132). As a non-limiting illustrative example, the thread dispatcher 106 may dispatch the first thread 112 to the core 104a, and the core 104a may execute an instruction of the first thread 112 that causes the core 104a to access the information 176, such as by loading the information 176 to the core 104a or to another core of the set of one or more processing cores 102.

One or more examples described with reference to FIG. 1 enable improved performance of a device. For example, by performing an inter-thread communication operation using the first message 160 and the second message 170, communication by copying data to a high-overhead shared memory accessed by multiple compute units may be avoided, which may reduce latency associated with copying data, writing the data to the shared memory, and retrieving the data from the shared memory. Further, the examples of FIG. 1 may enable point-to-point communication between threads without use of a “locking” a shared memory (e.g., without restricting access to the shared memory).

FIG. 2 illustrates an example of a system 200. The system 200 may include multiple processors, such as a first processor 202 (e.g., a first multiprocessor) and a second processor 252 (e.g., a second multiprocessor). To illustrate, one or both of the processors 202, 252 may correspond to a GPU, as a non-limiting example. In some implementations, the first processor 202 and the second processor 252 are integrated within a common package, such as in connection with a system-in-package (SiP) configuration. In another implementation, the first processor 202 may be included in a first package, and the second processor 252 may be included in a second package. The first package and the second package may be connected to a printed circuit board (PCB), as an illustrative example. The first processor 202 and the second processor 252 may each be included in a system-on-chip (SoC) device, as an illustrative example.

In some implementations, the first processor 202 and the second processor 252 correspond to “symmetric” processors that include certain common features, such as a common number of compute units. In other implementations, the first processor 202 and the second processor 252 correspond to “asymmetric” processors that include certain distinct features, such as different numbers of compute units. Further, although FIG. 2 illustrates two processors that each include four compute units, in other implementations, the system 200 may include a different number of processors (e.g., one processor or three or more processors), a different number of compute units (e.g., one, two, three, five, or more compute units per processor), or a combination thereof.

The system 200 may also include a connection 290 between the first processor 202 and the second processor 252. The first processor 202 may be configured to communicate with the second processor 252 (e.g., using the connection 290), and the second processor 252 may be configured to communicate with the first processor 202 (e.g., using the connection 290). The connection 290 may include an interface, such as a serializer-deserializer (SERDES) interface or a parallel chip-to-chip bus, as illustrative examples. Alternatively or in addition, the connection 290 may include a through-silicon via (TSV) that extends through a substrate of a semiconductor device that includes the first processor 202 or the second processor 252.

Each of the processors 202, 252 may include a set of compute units. For example, FIG. 2 illustrates that the first processor 202 may include the first compute unit 100 and the second compute unit 150 described with reference to FIG. 1. The first compute unit 100 may be configured to execute instructions of the first thread 112, and the second compute unit 150 may be configured to execute instructions of the second thread 152. One or more compute units illustrated in FIG. 2 may be as described with reference to the compute unit 100.

FIG. 2 depicts that the first processor 202 may further include a message passing router 204 (also referred to herein as a message passing fabric), a level-two (L2) cache 206, a double data rate (DDR) controller 208, and an L2 cache 210. FIG. 2 also depicts that the second processor 252 may include a message passing router 264, an L2 cache 266, a DDR controller 268, and an L2 cache 272. In some implementations, the system 200 may further include a “global” memory accessible to the processors 202, 252. For example, each of the L2 caches 206, 210, 266, and 272 may be coupled to the global memory.

The message passing router 264 may be coupled to one or more compute units of the second processor 252, and the message passing router 204 may be coupled to one or more compute units of the first processor 202. The message passing routers 204, 264 may be coupled to message passing devices and message buffers of compute units of the system 200. For example, the message passing router 204 may be coupled to the message passing device 130 of FIG. 1 and to the message buffer 132 of FIG. 1. As another example, the message passing router 204 may be coupled to a message passing device of the second compute unit 150 and to a message buffer of the second compute unit 150.

Depending on the particular implementation, the message passing routers 204, 264 may include one or more hardware components (e.g., a bus or other physical channel), a virtual network, a packet-switched network, or a combination thereof. Advantageously, in some examples, the message passing routers 204, 264 may include a packet-switched network that is configured to operate with multiple device topologies (e.g., by “learning” locations and identities of compute units and/or processors using a packet-switched communication technique).

The message passing router 204 may be configured to enable communication between compute units of the first processor 202, and the message passing router 264 may be configured to enable communication between compute units of the second processor 252. For example, the message passing router 204 may be configured to provide the first message 160 from the first compute unit 100 to the second compute unit 150. As another example, the message passing router 204 may be configured to provide the second message 170 from the second compute unit 150 to the first compute unit 100.

Alternatively or in addition to enabling communication between compute units of the first processor 202, the message passing router 204 may be configured to enable communication between the first processor 202 and the second processor 252. For example, a compute unit of the first processor 202 (e.g., the first compute unit 100 of the first processor 202) may send a third message 260 to a third compute unit 254 of the second processor 252 and may receive a fourth message 270 from the third compute unit 254. The message passing router 204 may be coupled to the first compute unit 100 and to the third compute unit 254. The message passing router 204 may provide the third message 260 from the first compute unit 100 to the third compute unit 254 and may provide the fourth message 270 from the third compute unit 254 to the first compute unit 100. To further illustrate, the first compute unit 100 may generate the third message 260 during execution of the first thread 112, and the third compute unit 254 may generate the fourth message 270 during execution of a third thread 262. In an illustrative example, the third compute unit 254 may be as described with reference to the second compute unit 150, the third message 260 may be as described with reference to the first message 160, and the fourth message 270 may be as described with reference to the second message 170.

In some implementations, a compute unit may send a message (e.g., one or more of the messages 160, 260) to multiple compute units (e.g., to each compute unit of the system 200). For example, the first message 160 may be a multicast message that is addressed to multiple compute units, to multiple threads, or a combination thereof. In this case, the destination field 164 of the first message 160 may indicate IDs of multiple compute units (e.g., a subset of compute units of the system 200), such as IDs of the compute units 150, 254. Alternatively or in addition, the destination field 164 may indicate IDs of multiple threads (e.g., a subset of threads of the system 200), such as IDs of the threads 152, 262. In some cases, a request may be broadcast to each compute unit of the system 200 or each thread of the system 200. In this case, the destination field 164 of the first message 160 may indicate IDs of each compute unit of the system 200, or the destination field 164 may have a particular value (e.g., an all ones value or an all zeros value, as illustrative examples) that indicates the first message 160 is to be broadcast to each compute unit of the system 200. To further illustrate, if the first compute unit 100 determines during execution of the first thread 112 that information (e.g., the information 176) is to be requested from multiple compute units of the system 200, then the destination field 164 may indicate multiple compute units, such as all of the compute units of the system 200, as an illustrative example.

Alternatively or in addition, a response (e.g., one or more of the messages 170, 270) to a request may be sent to multiple compute units of the system 200. For example, the destination field 174 of the second message 170 may indicate IDs of multiple compute units, such as IDs of the compute units 100, 254. In some cases, a request may be broadcast to each compute unit of the system 200. In this case, the destination field 174 of the second message 170 may indicate IDs of each compute unit of the system 200, or the destination field 174 may have a particular value (e.g., an all ones value or an all zeros value, as illustrative examples) that indicates the second message 170 is to be broadcast to each compute unit of the system 200. To further illustrate, if the third compute unit 254 determines during execution of the second thread 152 that information (e.g., the information 176) is to be provided to multiple compute units of the system 200, then the destination field 174 may indicate multiple compute units, such as all of the compute units of the system 200, as an illustrative example.

Alternatively or in addition to sending a message to multiple compute units of the system 200, a message may be sent to multiple threads of a particular compute unit. As an illustrative example, the second message 170 may be sent to multiple threads of the first compute unit 100, such as the set of threads 110. In this example, the destination field 174 may indicate thread IDs of multiple threads of the set of threads 110. To further illustrate, upon receipt of the second message 170 at the message buffer 132, the message passing device 130 may adjust values of the bits 122, 124, and 126 (e.g., to indicate that the second message 170 is available for the set of threads 110).

In some examples, a thread may receive a “many-to-one” communication that includes messages from multiple threads, multiple compute units, or both. To illustrate, the first thread 112 of the first compute unit 100 may send the first message 160 to the second thread 152 of the second compute unit 150 in connection with (e.g., concurrently with) sending the third message 260 to the third thread 262 of the third compute unit 254. In this example, the one or more bits 122 of FIG. 1 may include a first bit indicating availability or unavailability of the second message 170 and may further include a second bit indicating availability or unavailability of the fourth message 270. In some implementations, the one or more bits 122 may further include a third bit indicating whether the first thread 112 is to be scheduled for execution upon receipt of one message of multiple messages (e.g., upon receipt of either of the messages 170, 270) or upon receipt of each message of the multiple messages (e.g., upon receipt of both the messages 170, 270).

In some implementations, a compute unit may use a message passing router to perform one or more other operations using message passing (in addition to inter-thread communication operations). For example, the first compute unit 100 and/or the second compute unit 150 may use the message passing router 204 to access a local memory (e.g., the L2 cache 206, the L2 cache 210, or both), to access a remote memory, to communicate with another device (e.g., the DDR controller 208), or a combination thereof. As another example, the third compute unit 254 may use the message passing router 264 to access a local memory (e.g., the L2 cache 266, the L2 cache 272, or both), to access a remote memory, to communicate with another device (e.g., the DDR controller 268), or a combination thereof.

Although certain examples have been described with reference to generating responses (e.g., the messages 170, 270) in response to requests (e.g., the messages 160, 260), in some cases, a message may be generated without “prompting” from a request. In this case, the second compute unit 150 may generate the second message 170 without receipt of (or independently of) the first message 160. Alternatively or in addition, the third compute unit 254 may generate the fourth message 270 without receipt of (or independently of) the third message 260.

Further, although certain examples have been described with reference to sending a message from one compute unit to another compute unit, it should be appreciated that in some implementations a thread of a compute unit may communicate with another thread of the compute unit (e.g., in connection with an intra-compute unit communication). To illustrate, in some cases, the first thread 112 may send the first message 160 to the thread 114 or the thread 116 of FIG. 1, and the second message 170 may be received from the thread 114 or the thread 116 of FIG. 1. In some implementations, the message passing device 130 may be configured to refrain from modifying a value of one or more bits at the event register 120 in connection with an intra-compute unit communication. As an example, if the first thread 112 is to send the first message 160 to the thread 114 FIG. 1, the message passing device 130 may store the first message 160 at the message buffer 132, and the message passing device 130 may alert the thread 114 during a subsequent clock cycle of availability of the first message 160. Sending a message from a thread of a compute unit to another thread of a compute unit in such a manner may reduce or avoid certain communications on a shared memory bus, reducing communication latency and memory bandwidth usage.

The aspects described with reference to FIG. 2 may enable improved performance of a device. For example, by performing inter-thread communication operations using the messages 160, 170, 260, and 270, communication by copying data to a shared memory may be avoided, which may reduce latency associated with copying data, writing the data to a shared memory, and retrieving the data from the shared memory. Further, the message passing routers 204, 264 may include low-overhead message passing interconnects associated with relatively low latency, which may improve speed of inter-thread communication operations as compared to using a shared memory interface that is configured to perform “bulk” transfer of large amounts of data (e.g., files).

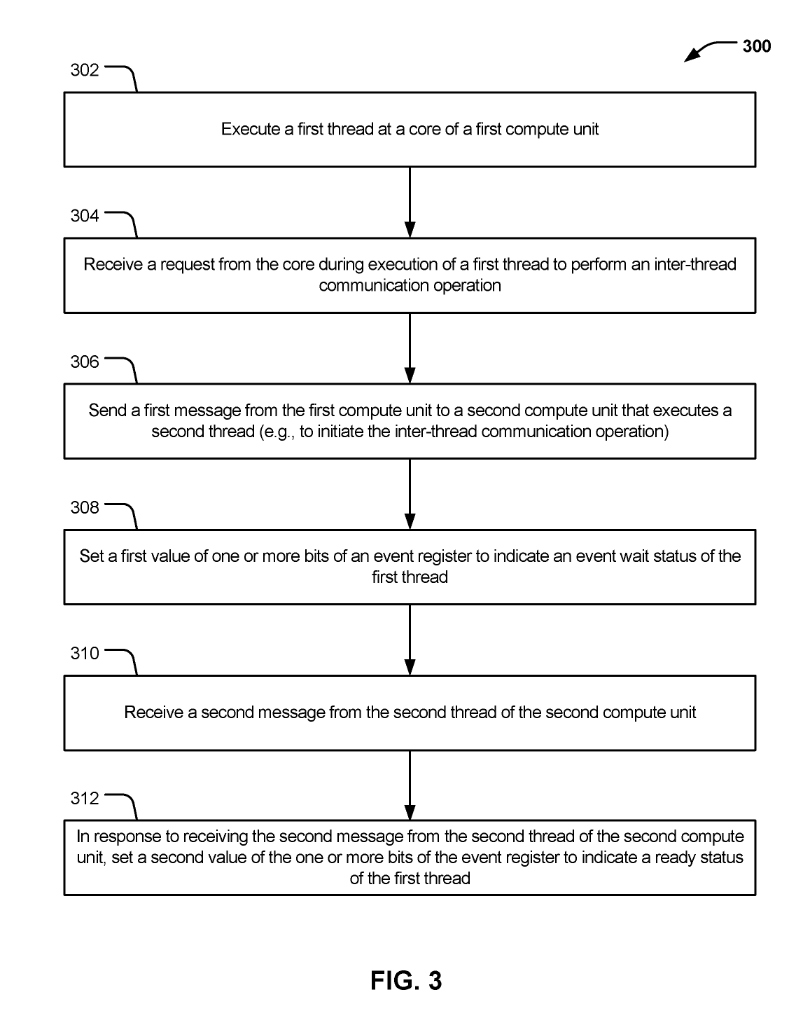

FIG. 3 is a diagram of an illustrative example of a method 300 of operation of a compute unit. The compute unit may correspond to the compute unit 100 of FIGS. 1 and 2, as an illustrative example.

The method 300 includes executing a first thread at a core of a first compute unit, at 302. To illustrate, the thread dispatcher 106 may dispatch one or more threads of the set of threads 110 to be executed by one or more cores of the set of one or more processing cores 102. As a particular illustrative example, the thread dispatcher 106 may dispatch the first thread 112 to be executed by the core 104a.

The method 300 further includes receiving a request from a core of the set of cores during execution of a first thread of the set of threads to perform an inter-thread communication operation, at 304. For example, during execution of the first thread 112 by the core 104a, the core 104a may execute an instruction that causes the core 104a to provide the request 138 to the thread dispatcher 106.

The method 300 further includes sending a first message from the first compute unit to a second compute unit that executes a second thread (e.g., to initiate the inter-thread communication operation), at 306. For example, the first compute unit 100 may send the first message 160 to the second thread 152 of the second compute unit 150.

The method 300 further includes setting, in response to the request, one or more bits in an event register to a first value indicating an event wait status associated with the first thread, at 308. As an illustrative example, the thread dispatcher 106 may set the one or more bits 122 to indicate that the first thread 112 has an event wait status.

The method 300 further includes receiving a second message from the second thread of the second compute unit, at 310. For example, the second message 170 may be received by the first compute unit 100, such as at the message buffer 132.

The method 300 further includes setting, in response to receiving the second message from the second thread of the second compute unit, the one or more bits in the event register to a second value to indicate a ready status of the first thread, at 312. As an illustrative example, the thread dispatcher 106 may set the one or more bits 122 to indicate a ready status of the first thread 112.

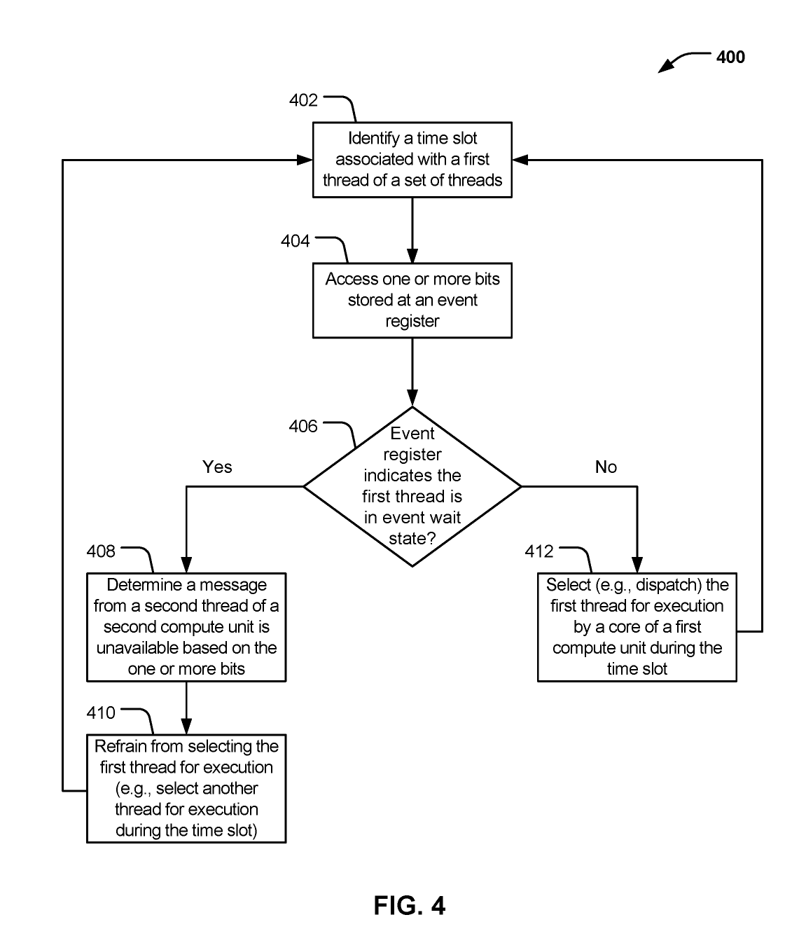

The method 300 of FIG. 3 may be performed by a compute unit to set bits at an event register, such as the event register 120 of FIG. 1. In an illustrative implementation, the compute unit may access the event register to determine execution of a set of threads (e.g., the set of threads 110), as described further with reference to FIG. 4.

FIG. 4 is a diagram of an illustrative example of a method 400 of operation of a compute unit. The compute unit may correspond to the compute unit 100 of FIGS. 1 and 2, as an illustrative example.

The method 400 includes identifying a time slot associated with a first thread of a set of threads, at 402. For example, the thread dispatcher 106 may identify a particular time slot associated with (e.g., reserved for) execution of the first thread 112 of the set of threads 110.

The method 400 further includes accessing one or more bits stored at an event register, at 404. As an illustrative example, the thread dispatcher 106 may access the one or more bits 122 stored at the event register 120.

The method 400 further includes determining whether the event register indicates that the first thread is in an event wait state, at 406. To illustrate, the one or more bits 122 may indicate whether the first thread is in an event wait state. In some examples, a first value (e.g., a logic one value) of the one or more bits 122 indicates that the first thread is in an event wait state (e.g., upon initiating sending of the first message 160 and prior to receipt of the second message 170).

If the event register indicates that the first thread is in an event wait state, the method 400 further includes determining that a message from a second thread of a second compute unit is unavailable based on the one or more bits, at 408. For example, the thread dispatcher 106 may determine based on a first value of the one or more bits 122 that the second message 170 from the second thread 152 of the second compute unit 150 is unavailable (e.g., has not been received at the first compute unit 100). The method 400 further includes refraining from selecting the first thread for execution, at 410. For example, the thread dispatcher 106 may select another thread for execution during the time slot, such as by selecting the thread 114 or the thread 116 for execution during the time slot. Alternatively, if no thread of the first compute unit 100 has a ready state, then the set of one or more processing cores 102 may idle during the time slot.

If the event register indicates that the first thread is in a ready state, the method 400 further includes selecting (e.g., dispatching) the first thread for execution by a core of a first compute unit during the time slot, at 412. For example, in response to detecting a second value of the one or more bits 122, the thread dispatcher 106 may select the first thread 112 for execution by the core 104a during the time slot.

One or more hardware components may be used to perform one or more operations of the method 300 of FIG. 3, one or more operations of the method 400 of FIG. 4, one or more other operations described herein, or a combination thereof. In a non-limiting illustrative example, the thread dispatcher 106 may include a comparator circuit and a multiplexer circuit coupled to the comparator circuit. The multiplexer circuit may be configured to selectively access bits of the event register 120, such as by accessing the one or more bits 122 based on receiving an indication of a thread ID of the first thread 112 at an input of the multiplexer circuit. The comparator circuit may include an input configured to receive the one or more bits 122 from an output of the multiplexer circuit. The comparator circuit may be configured to compare the one or more bits 122 to a reference value (e.g., a logic one value, as an illustrative example) to determine whether the one or more bits 122 indicate an event wait status or a ready status. For example, an output of the comparator circuit may indicate an event wait status or a ready status.

Alternatively or in addition, instructions may be retrieved from a memory (e.g., a non-transitory computer readable medium) and executed to perform one or more operations of the method 300 of FIG. 3, one or more operations of the method 400 of FIG. 4, one or more other operations described herein, or a combination thereof. In a non-limiting illustrative example, in some implementations, the thread dispatcher 106 may include a microprocessor configured to execute an instruction to selectively access bits of the event register 120, such as by executing the instruction to access the one or more bits 122. The instruction may include an argument indicating a thread ID of the first thread 112. The microprocessor may be further configured to execute an instruction to compare the one or more bits 122 to a reference value (e.g., a logic one value, as an illustrative example) to determine whether the one or more bits 122 indicate an event wait status or a ready status.

An ISA in accordance with the disclosure may include a set of instructions including one or more of a first instruction, a second instruction, a third instruction, and a fourth instruction. The set of instructions is executable by a compute unit, such as any of the compute units 100, 150, and 254. The first instruction may be executable by the compute unit to construct a fabric header. The first instruction may include an argument (or opcode) to receive an address of an integrated circuit, an indication of a compute unit, or both (e.g., <chip_number, compute_unit_number>). In a particular example, a particular value of the argument may cause a message (e.g., any of the messages 160, 170, 260, and 270) to be broadcast to each compute unit of a particular integrated circuit. The second instruction may be executable by the compute unit to perform one or more operations of a message passing device (e.g., the message passing device 130) and to send a message (e.g., any of the messages 160, 170, 260, and 270) of N bytes (where N is a positive integer) to the address specified by the first instruction. The third instruction may be executable by the compute unit to associate a thread (e.g., the first thread 112) with an event wait status, which may “disqualify” the thread from being scheduled for execution in some implementations. The fourth instruction may be executable by the compute unit to clear a state of the event register 120, such as in response to power-up of the first compute unit 100, as an illustrative example.

One or more aspects described herein may be applied to a variety of applications. To illustrate, in a neural network application, a thread of a compute unit (e.g., the first thread 112 of the first compute unit 100) may correspond to a set of one or more neurons, such as in connection with a parallelized deep learning application performed by a GPU. Upon completing a particular operation (e.g., performing an activation function to generate an input to multiple other neurons in the system), the thread may provide a result of the operation to one or more other neurons (or threads) in the system. The result may be provided using an inter-thread communication operation, such as using the second message 170. In this example, the information 176 may include the result of the operation.

To further illustrate, in a graph-based analytics application, a thread of a compute unit (e.g., the first thread 112 of the first compute unit 100) may correspond to a node (or a vertex) connected to other nodes (or threads). An example of a graph-based analytics application is a breadth first search (BFS) process. In a BFS process, a graph may be represented as a set of adjacency lists, where each node is associated with a set of adjacent nodes. In response to an indication of a particular node, the graph may be analyzed to determine other nodes that may be reached within a particular range of the particular node (e.g., within k hops of the particular node, where k is a positive integer). A BFS search process may be used in connection with a route planning application or a social analytics application, as illustrative examples. For a large graph, a BFS process may be parallelized, and each thread may be assigned a set of vertices. In each iteration, a thread may exchange information (e.g., the information 176) with other vertices (or threads) in the system. Thus, an inter-thread communication operation may enable point-to-point communication between threads, increasing workload efficiency. Other illustrative applications include a page rank graph analytics application, a dimensionality reduction application (e.g., singular value decomposition (SVD) process or a principal component analysis (PCA) process), a signal processing application (e.g., a fast Fourier transform (FFT) application), and data sorting (e.g., large scale data sorting, such as a terasort process), as illustrative examples.

A device or component described herein may be represented using data. As an example, an electronic design program may specify a group of components to enable a user to design an integrated circuit that includes one or more components described herein. Data representing such components may be provided to a circuit designer to design a circuit, to a physical layout creator that designs a physical layout for the circuit, to a semiconductor foundry (or “fab”) that fabricates integrated circuits based on the physical layout, a testing entity that tests the integrated circuits, to a packaging entity that integrates the integrated circuits into packages, to an assembly entity that assembles packaged integrated circuits onto printed circuit board and/or into electronic devices, to one or more other entities, or a combination thereof. Examples of electronic devices include computers (e.g., servers, desktop computers, laptop computers, and tablet computers), phones (e.g., cellular phones and landline phones), network devices (e.g., base stations and access points), communication devices (e.g., modems, routers, and switches), and vehicle control systems (e.g., an electronic control unit (ECU) of a vehicle), as illustrative examples.

The examples described above are provided for illustration and are not intended to be limiting. Those of skill in the art will appreciate that modifications to the examples may be made without departing from the scope of the disclosure.

What is claimed is:

1. An apparatus comprising:
a set of one or more processing cores of a first compute unit, the set of one or more processing cores configured to execute a set of threads;
a thread dispatcher of the first compute unit, the thread dispatcher coupled to the set of one or more processing cores and configured to select threads of the set of threads for execution by the set of one or more processing cores; and
an event register of the first compute unit, the event register coupled to the thread dispatcher and configured to store one or more bits associated with a message from a second thread of a second compute unit,
wherein the thread dispatcher is further configured to refrain from selecting a first thread of the set of threads for execution in response to a first value of the one or more bits and to select the first thread for execution in response to a second value of the one or more bits.

2. The apparatus of claim 1, further comprising a message passing device coupled to the thread dispatcher and configured to send an outgoing message to the second compute unit.

3. The apparatus of claim 2, wherein the outgoing message indicates a request for information from the second thread, and wherein the message received from the second thread includes the information.

4. The apparatus of claim 2, further comprising a message buffer coupled to the message passing device and configured to store the message from the second thread.

5. The apparatus of claim 4, wherein the thread dispatcher is further configured to determine that the message is stored at the message buffer based on the first value of the one or more bits.

6. The apparatus of claim 5, wherein the thread dispatcher is further configured to set the second value of the one or more bits in response to the message.

7. The apparatus of claim 6, wherein the first value indicates an event wait status of the first thread, and wherein the second value indicates a ready status of the first thread.

8. The apparatus of claim 1, further comprising a processor that includes the first compute unit and the second compute unit.

9. The apparatus of claim 8, further comprising a message passing router that is included in the processor, the message passing router coupled to the first compute unit and the second compute unit and configured to provide the message from the second compute unit to the first compute unit.

10. The apparatus of claim 1, further comprising a first processor that includes the first compute unit, the first processor configured to communicate with a second processor that includes the second compute unit.

11. The apparatus of claim 10, wherein the first processor is further configured to communicate with the second processor using a connection between the first processor and the second processor.

12. The apparatus of claim 11, wherein the connection includes a through-silicon via (TSV), a serializer-deserializer (SERDES) interface, or a parallel chip-to-chip bus.

13. The apparatus of claim 1, wherein the message comprises a multicast message that is addressed to multiple compute units, to multiple threads, or a combination thereof.

14. A method of operation of a compute unit, the method comprising:
executing a first thread at a first compute unit;
sending a first message from the first compute unit to a second compute unit that executes a second thread;
setting a first value of one or more bits of an event register to indicate an event wait status of the first thread;
receiving a second message from the second thread of the second compute unit; and
in response to receiving the second message from the second thread of the second compute unit, setting a second value of the one or more bits of the event register.

15. The method of claim 14, further comprising:
identifying a time period associated with the first thread;
accessing the event register; and
in response to detecting the second value of the one or more bits, selecting the first thread for execution at the first compute unit.

16. The method of claim 14, wherein the first thread is not selected for execution while the one or more bits have the first value.

17. The method of claim 14, wherein the second message is received at a message buffer of the first compute unit.

18. The method of claim 14, wherein the first message and the second message enable the first thread to synchronize with the second thread.

19. The method of claim 14, further comprising receiving a request from a core during execution of the first thread.

20. The method of claim 14, wherein the second message comprises a multicast message that is addressed to multiple compute units, to multiple threads, or a combination thereof.
